(19) United States
(12) Patent Application Publication
(10) Pub. No.: US 2018/0275871 A1
(43) Pub. Date: Sep. 27, 2018

(54) SIMULATION OF A PLURALITY OF STORAGE DEVICES FROM A SINGLE STORAGE DEVICE COUPLED TO A COMPUTATIONAL DEVICE

(71) Applicant: INTEL CORPORATION, Santa Clara, CA (US)

(72) Inventor: Slawomir PTAK, Gdansk (PL)

(21) Appl. No.: 15/466,648

(22) Filed: Mar. 22, 2017

(51) Int. Cl. G06F 3/06

(52) U.S. Cl. CPC G06F 3/061; G06F 3/0688; G06F 3/0664; G06F 3/0665; G06F 3/0655

(57) ABSTRACT

A computational device generates a plurality of logical storage devices from a single physical storage device coupled to the computational device. A plurality of physical storage devices are simulated via the plurality of logical storage devices. The plurality of physical storage devices and the single physical storage device are of a same type.

### BACKGROUND

A computational device may be coupled to one or more physical storage devices in which data may be stored. A storage device driver is a computer program that may control a particular type of physical storage device that is coupled to the computational device. The operating system of the computational device may use one or more storage device drivers to satisfy input/output (I/O) requests received from applications that execute in the computational device.

A block is a sequence of bits or bytes that are used for storing data. Logical block addressing (LBA) is a scheme used for specifying the location of blocks of data stored in physical storage devices, such as hard disk drives. LBA is a linear addressing scheme in which blocks may be located via an integer index, with the first block being referred to LBA 0, the second being referred to as LBA 1, and so on.

Non-Volatile Memory Express (NVMe) is a protocol for the transport of data to and from NAND flash and other types of solid state technologies. Storage devices that are accessible from a computational device via the NVMe protocol may be referred to as NVMe devices. Further details of NVMe may be found in www.nvmexpress.org.

Redundant array of independent disks (RAID) is a data storage virtualization technology that combines multiple physical disk drives into a single logical unit for the purposes of data redundancy, performance improvement, or both. Data is distributed across the disk drives via one of several configurations of the disk drives. The configurations of the disk drives are referred to as RAID levels, where different RAID levels have different levels of redundancy and performance.

### BRIEF DESCRIPTION OF THE DRAWINGS

Referring now to the drawings in which like reference numbers represent corresponding parts throughout:

FIG. 1 illustrates a block diagram that shows a computational device coupled to a plurality of physical storage devices, in accordance with certain embodiments;

FIG. 2 illustrates a block diagram that shows a computational device coupled to a single physical storage device, where a plurality of the physical storage devices are simulated in the computational device via a plurality of logical storage devices generated from the single physical storage device, in accordance with certain embodiments;

FIG. 3 illustrates a block diagram that shows the simulation of a plurality of physical storage devices based on partitioning a single physical storage device into a plurality of logical block address ranges, where each logical block address range is mapped to a logical storage device, in accordance with certain embodiments;

FIG. 4 illustrates a block diagram that shows the simulation of a plurality of physical storage devices based on generating a plurality of namespaces from a single NVMe device, where each namespace is mapped to a logical NVMe device, in accordance with certain embodiments;

FIG. 5 illustrates a flowchart that shows the simulation of a plurality of physical storage devices from a single physical storage device coupled to a computational device, in accordance with certain embodiments; and

FIG. 6 illustrates a block diagram of a system including a computational device, in accordance with certain embodiments.

### DETAILED DESCRIPTION

In the following description, reference is made to the accompanying drawings which form a part hereof and which illustrate several embodiments. It is understood that other embodiments may be utilized and structural and operational changes may be made.

In certain embodiments, a computational device simulates a plurality of physical storage devices by using the functions provided by a single physical storage device that is coupled to the computational device.

In certain embodiments, the computational device generates a plurality of logical storage devices from the single physical storage device coupled to the computational device. The plurality of physical storage devices are simulated via the plurality of logical storage devices.

As a result, in situations where physical storage devices are expensive or are not readily available, the single physical storage device may be used for testing and development of software that needs a plurality of physical devices. For example, the development and testing of RAID software that needs a plurality of physical storage devices may be accomplished by coupling a single physical storage device to the computational device and simulating the plurality of physical storage devices from the single physical storage device.

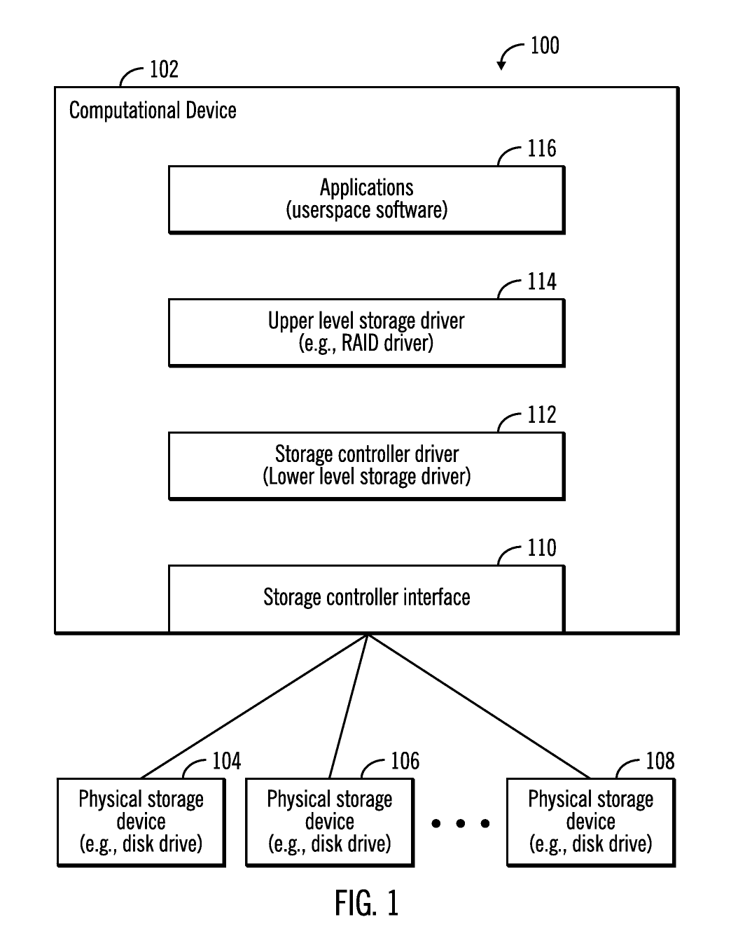

FIG. 1 illustrates a block diagram 100 that shows a computational device 102 coupled to a plurality of physical storage devices 104, 106, 108, in accordance with certain embodiments.

The computational device 102 may comprise any suitable computational device including those presently known in the art, such as, a personal computer, a workstation, a server, a mainframe, a hand held computer, a palm top computer, a telephony device, a network appliance, a blade computer, a processing device, etc. The physical storage devices 104, 106, 108 may comprise any suitable physical storage devices, such as hard disk drives, solid state drives, etc. In certain embodiments, the computational device 102 may communicate with the physical storage device 104, 106, 108 over a bus (such as a Peripheral Component Interconnect Express (PCIe) bus, Serial Advanced Technology Attachment (SATA) bus, Serial Attached Small Computer System Interface (SAS) bus), or a network, such as the Internet, a storage area network (SAN), a local area network (LAN), etc., or a logical device interface, such as NVM Express (NVMe). Further details of NVMe may be found in the publication, “NVM Express” Revision 1.2.1., Published Jun. 5, 2016 by NVM Express, Inc. The computational device 102, and the physical storage devices 104, 106, 108 may be elements in any suitable network, such as, a storage area network, a wide area network, the Internet, an intranet, etc. In certain embodiments, the computational device 102 and the physical storage devices 104, 106, 108 may be elements in a cloud computing environment.

One or more storage controller interfaces 110 may be used to couple the computational device 102 to the plurality of physical storage device 104, 106, 108. A storage controller driver 112 (also referred to as a lower level storage driver) may provide functions that allow an upper level storage driver 114 to communicate with the plurality of physical storage devices 104, 106, 108. In certain embodiments, the upper level storage driver 114 may need more than one physical storage device for development and testing. For example, if the upper level storage driver 114 is a RAID driver, then unless the plurality of physical storage devices 104, 106, 108 are more than the number required for the RAID configuration, the RAID driver may not be developed or tested property. In the embodiments shown in FIG. 1, there are a plurality of physical storage devices 104, 106, 108 that are adequate for the development and testing of the upper level storage driver 114. Other applications 116 that may comprise userspace software (i.e., software that executes in the memory space allocated to user applications) may also execute in the computational device 102 and use the upper level storage driver 114.

There may be situations in which the physical storage devices 104, 106, 108 are expensive or not readily available and it may be desirable to minimize the number of physical storage devices to use for development and testing of the upper level storage driver 114 and the applications 116.

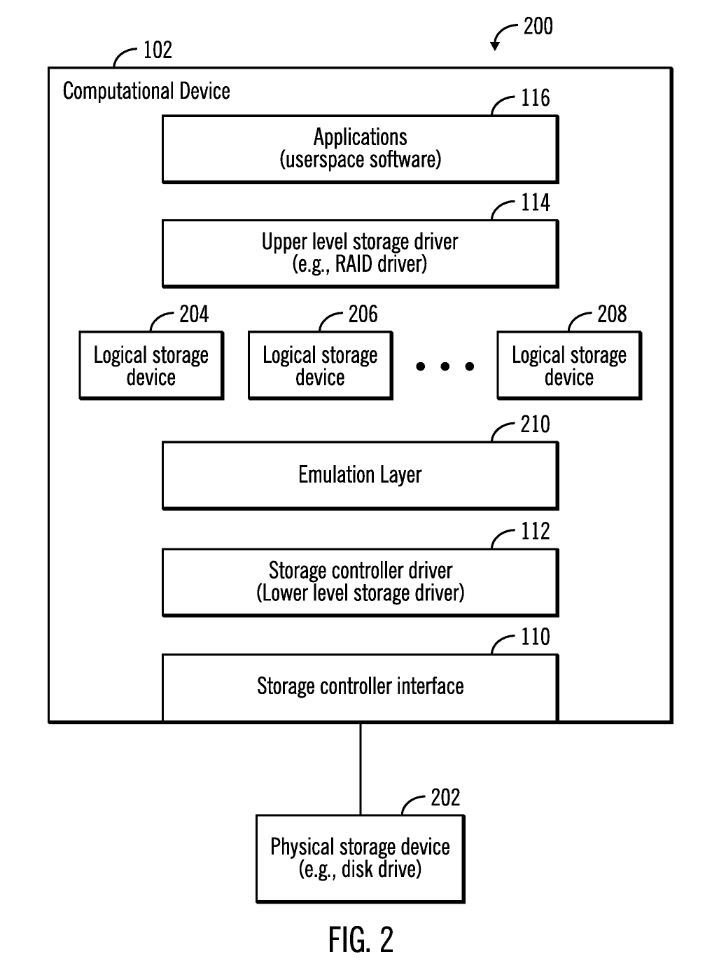

Certain embodiments shown in FIGS. 2-6 provide configurations in which a single physical storage device (e.g., physical storage device 104) suffices for development and testing of the upper level storage driver 114 and the applications 116.

FIG. 2 illustrates a block diagram 200 that shows the computational device 102 coupled to a single physical storage device 202, where a plurality of physical storage devices are simulated in the computational device 102 via a plurality of logical storage devices 204, 206, 208 generated from the single physical storage device 202, in accordance with certain embodiments.

In certain embodiments, an emulation layer 210 in the computational device 102 performs the generating of the plurality of logical storage devices 204, 206, 208, and the simulating of the plurality of physical storage devices from the plurality of logical storage devices 204, 206. 208. The emulation layer 210 interfaces between the upper level storage driver 114 and the storage controller driver 112 of the single physical storage device 202. In certain embodiments, the emulation layer 210 may be implemented in software, hardware, firmware or any combination thereof.

The testing and development of the upper level storage driver 114 is performed by the simulating of the plurality of physical storage devices. The single physical storage device 202 is adequate to simulate the plurality of physical storage devices, and any command directed to any of the plurality of physical storage devices by the upper level storage driver 114 or the applications 116 is directed to the single physical storage device 202, via the emulation later 210, the storage controller driver 112, and the storage controller interface 110.

In certain embodiments shown in FIG. 2, if the upper level storage driver 114 is a RAID driver, then the RAID driver configures the plurality of physical storage devices as a RAID while using only a single physical disk drive 202. No additional physical disk drives have to be coupled to the computational device 102.

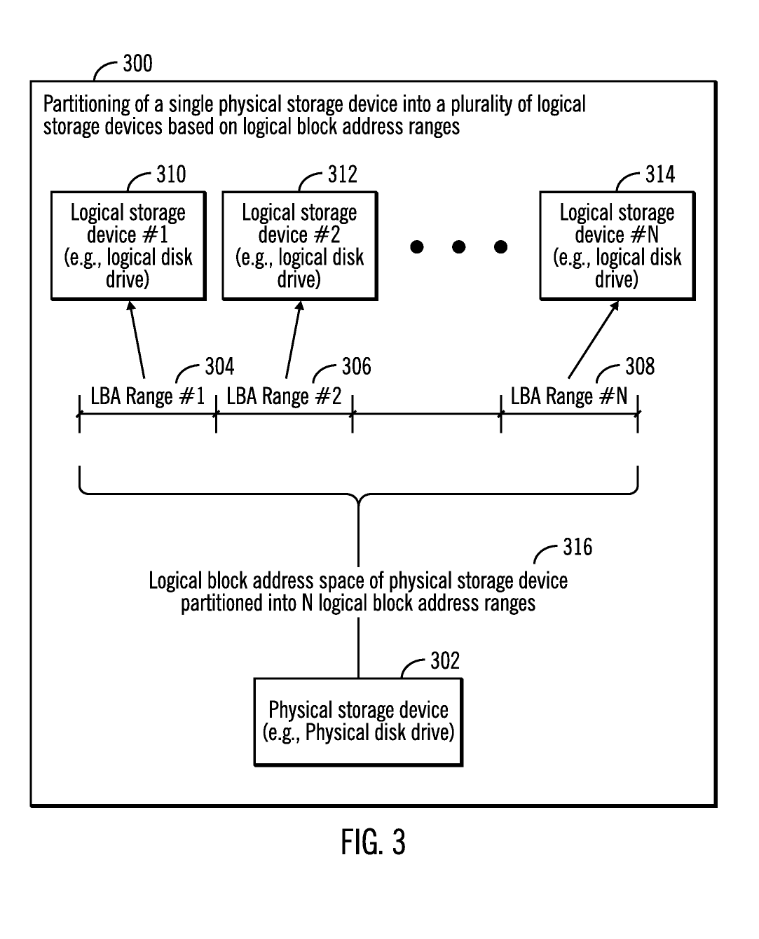

FIG. 3 illustrates a block diagram 300 that shows the simulation of a plurality of physical storage devices based on partitioning a single physical storage device 302 into a plurality of logical block address ranges 304, 306, 308, where each logical block address range is mapped to a logical storage device 310, 312, 314 in accordance with certain embodiments.

In certain embodiments, the emulation layer 210 partitions the logical block address space of the physical storage derive 302 into the plurality of logical block address ranges (as shown via reference numeral 316).

Therefore, FIG. 3 shows certain embodiments in which the emulation layer 210 partitions the single physical storage device 302 into a plurality of logical block address ranges 304, 306, 308 and maps each logical block address range to a logical storage device of the plurality of logical storage devices 310, 312, 314. For example logical block address range #1 304 is mapped to logical storage device #1 310, logical block address range #2 306 is mapped to logical storage device #3 312, and logical block address range #N 308 is mapped to logical storage device #N 314. In certain embodiments, a logical block address range is a set of sequential logical block addresses.

In FIG. 3, in certain embodiments, a single physical drive is partitioned into multiple LBA ranges by the emulation layer 210. Then, the single physical drive is reported as multiple drives to the upper level software layers 114, 116. All the commands directed to drives are redirected to the single physical drive with no changes, with the following exceptions:

1. Serial number for the simulated drives is generated, based on the physical drive's serial number;
2. The capacity of each simulated drives is less than the single physical drive; and
3. The target LBA for read and write commands is shifted.

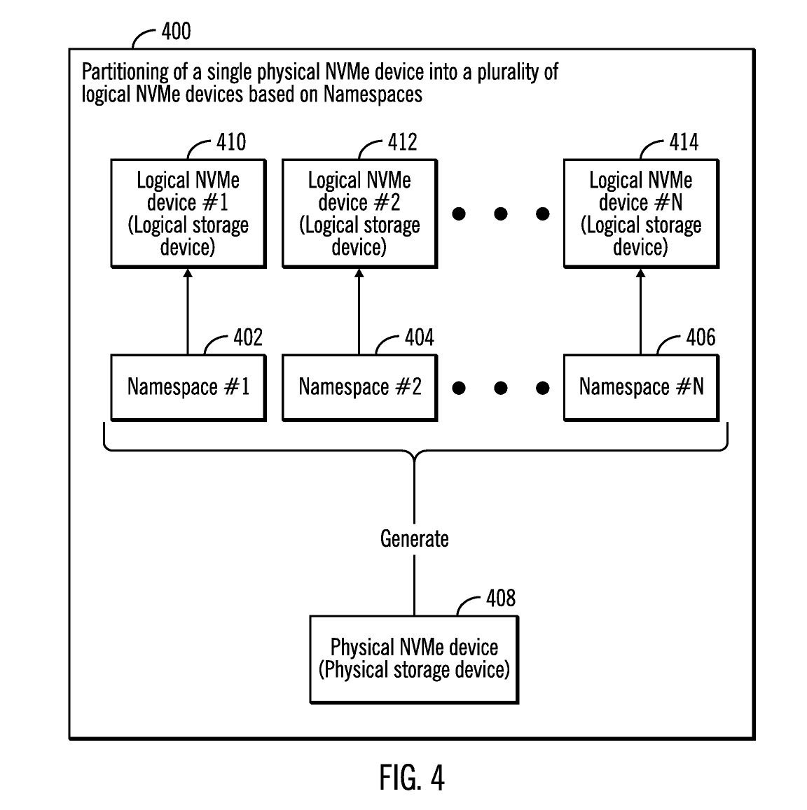

FIG. 4 illustrates a block diagram 400 that shows the simulation of a plurality of physical storage devices based on generating a plurality of namespaces 402, 404, 406 from a single NVMe device 408, where each namespace is mapped to a logical NVMe device 410, 412, 414, in accordance with certain embodiments.

FIG. 4 shows certain embodiments in which the computational device 102 communicates with the single physical storage device 408 via an NVMe protocol. The emulation layer 210 generates a plurality of namespaces 402, 404, 406 from the single physical storage device 408 which is a physical NVMe device, by sending a command to the physical NVMe device 408 via the storage controller driver 112 and the storage controller interface 110. The emulation layer 210 maps each namespace of the plurality of namespaces 402, 404, 406 to a logical storage device of the plurality of logical storage devices 410, 412, 414, where a logical storage device is a logical NVMe device. For example, Namespace #1 402 is mapped to logical NVMe device #1 410, Namespace #2 404 is mapped to logical NVMe device #2 412, Namespace #N 406 is mapped to logical NVMe device #N 414.

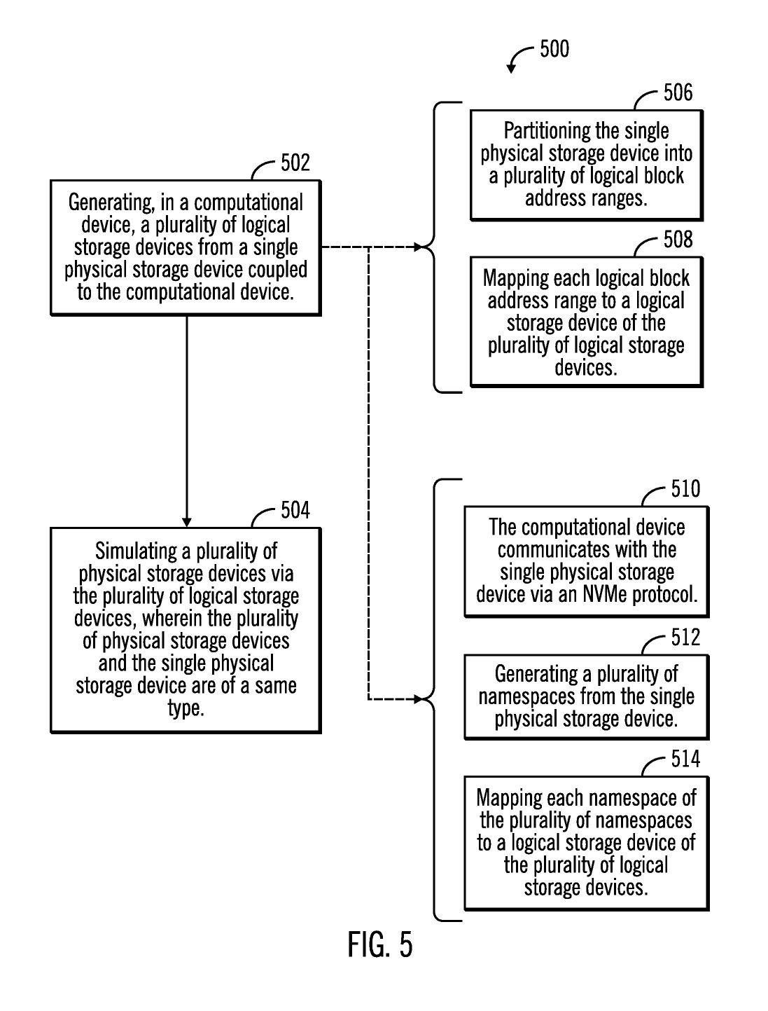

FIG. 5 illustrates a flowchart 500 that shows the simulation of a plurality of physical storage devices from a single physical storage device 202 coupled to a computational device 102, in accordance with certain embodiments.

Control starts at block 502, in which a computational device 102 generates a plurality of logical storage devices 204, 206, 208 from a single physical storage device 202 coupled to the computational device 102. A plurality of physical storage devices are simulated (at block 504) via the plurality of logical storage devices 204, 206, 208, wherein the plurality of physical storage devices and the single physical storage device 202 are of a same type. For example, in certain embodiments, in which the single physical storage device is a hard drive, a plurality of hard drives may be simulated by the emulation layer 210.

In certain embodiment the operations shown in block 502 may be performed by operations shown in blocks 506, 508, and in other embodiments the operations shown in block 502 may be performed by operations shown in blocks 510, 512, 514.

In block 506, the emulation layer 210 partitions a single physical storage device into a plurality of logical block address ranges 304, 306, 308 and then maps (at block 508) each logical block address range to a logical storage device of the plurality of logical storage devices 310, 312, 314.

In block 510, the computational device 102 communicates with a single physical storage device via the NVMe protocol. The emulation layer 210 generates (at block 512) a plurality of namespaces 402, 404, 406 from the single physical storage device which is a physical NVMe device. The emulation layer 210 maps (at block 514) each namespace of the plurality of namespaces 402, 404, 406 to a logical storage device of the plurality of logical storage devices 410, 412, 414, where a logical storage device is a logical NVMe device.

Therefore, certain embodiments shown in FIGS. 1-5 provide mechanisms for storage software development in an operating system environment. A single drive may be partitioned into logical block address (LBA) ranges (or namespaces) and each part corresponding to an LBA range may be reported as a separate drive to the operating system and to other software components. The partitioning is performed in an emulation layer, with minimal or no impact to the rest of the driver code. As a result, only a single drive has to be connected to the computational device, and the single drive may act as a plurality of drives. This single drive handles all the protocol specific commands (e.g. NVMe), so complex software emulation is avoided.

There is no need for complex software emulation of the drive, as may be the case in situations in which no physical drive is used. The embodiments execute in a computational device that is coupled to a physical drive. Such a configuration provides a higher confidence level for development and test, compared to configurations in which hardware components are emulated in software. Since all the I/O and administration commands are handled by the physical drive, a single version of the emulation layer may simulate drives compliant with any version of a storage protocol that is provided by any vendor. Software that is positioned above the storage controller driver 112 has an ability to access the simulated drives and operates in the same way as having multiple physical drives attached to the system.

Although various embodiments are described with respect to physical storage devices that comprise hard disk drives or solid state drives (SSD), embodiments may be applied to any physical storage device that comprise non-volatile memory. In one embodiment, the physical storage device is a block addressable memory device, such as those based on NAND or NOR technologies. A physical storage device may also include future generation nonvolatile devices, such as a three dimensional crosspoint memory device, or other byte addressable write-in-place nonvolatile memory devices. In one embodiment, the physical storage device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), magnetoresistive random access memory (MRAM) memory that incorporates memristor technology, or spin transfer torque (STT)-MRAM, a spintronic magnetic junction memory based device, or a combination of any of the above, or other memory. The physical storage device may refer to the die itself and/or to a packaged memory product.

The described components and/or operations may be implemented as a method, apparatus or computer program product using standard programming and/or engineering techniques to produce software, firmware, hardware, or any combination thereof. The described operations may be implemented as code maintained in a “computer readable storage medium” for implementation in certain embodiments or for software simulation of a memory chip for design purposes, where a processor may read and execute the code from the computer storage readable medium. The computer readable storage medium includes at least one of electronic circuitry, storage materials, inorganic materials, organic materials, biological materials, a casing, a housing, a coating, and hardware. A computer readable storage medium may comprise, but is not limited to, a magnetic storage medium (e.g., hard drive drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), Solid State Devices (SSD), etc. The code implementing the described operations may further be implemented in hardware logic implemented in a hardware device (e.g., an integrated circuit chip, Programmable Gate Array (PGA), Application Specific Integrated Circuit (ASIC), etc.). Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The program code embedded on a computer readable storage medium may be transmitted as transmission signals from a transmitting station or computer to a receiving station or computer. A computer readable storage medium is not comprised solely of transmission signals. Those skilled in the art will recognize that many modifications may be made to this configuration, and that the article of manufacture may comprise suitable information bearing medium known in the art.

Computer program code for carrying out operations for aspects of the certain embodiments may be written in any combination of one or more programming languages. Blocks of flowcharts and/or block diagrams may be implemented by computer program instructions.

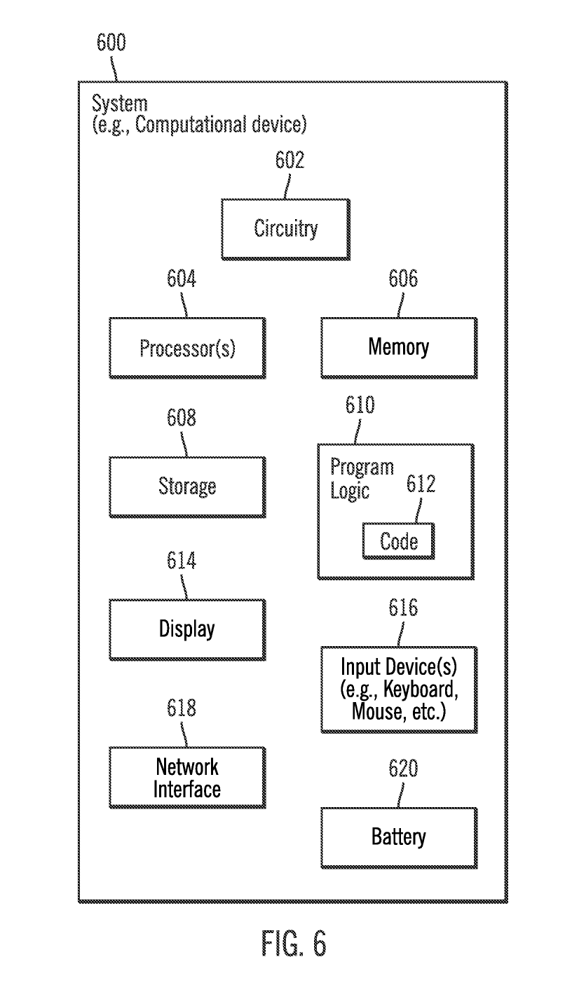

FIG. 6 illustrates a block diagram of a system 600 that may include a computational device 102 where a physical storage device 202, 302, 408 is included or coupled to the computational device 102. For example, in certain embodiments the system 600 may be a computer (e.g., a laptop computer, a desktop computer, a tablet, a cell phone or any other suitable computational device) that has a storage or memory device in the computer. The system 600 may include a circuitry 602 that may in certain embodiments include at least a processor 604. The system 600 may also include a memory 606, and storage 608. The storage 608 may include a solid state drive, a disk drive, or other drives or devices including a non-volatile memory device (e.g., EEPROM, ROM, PROM, flash, firmware, programmable logic, etc.). The storage 608 may also include a magnetic disk drive, an optical disk drive, a tape drive, etc. The storage 608 may comprise an internal storage device, an attached storage device and/or a network accessible storage device. The system 600 may include a program logic 610 including code 612 that may be loaded into the memory 606 and executed by the processor 604 or circuitry 602. In certain embodiments, the program logic 610 including code 612 may be stored in the storage 608. In certain other embodiments, the program logic 610 may be implemented in the circuitry 602. Therefore, while FIG. 6 shows the program logic 610 separately from the other elements, the program logic 610 may be implemented in the memory 606 and/or the circuitry 602. The system 600 may also include a display 614 (e.g., an liquid crystal display (LCD), a light emitting diode (LED) display, a cathode ray tube (CRT) display, a touchscreen display, or any other suitable display). The system 600 may also include one or more input devices 616, such as, a keyboard, a mouse, a joystick, a trackpad, or any other suitable input devices. In certain embodiments, the display 614 may be coupled to a memory or storage device comprising the storage 608 and/or the memory 606; a network interface 618 may be communicatively coupled to the processor 604; and a battery 620 may be communicatively coupled to the processor 604. Other components or devices beyond those shown in FIG. 6 may also be found in the system 600.

Certain embodiments may be directed to a method for deploying computing instruction by a person or automated processing integrating computer-readable code into a computing system, wherein the code in combination with the computing system is enabled to perform the operations of the described embodiments.

The terms “an embodiment”, “embodiment”, “embodiments”, “the embodiment”, “the embodiments”, “one or more embodiments”, “some embodiments”, and “one embodiment” mean “one or more (but not all) embodiments” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments need not include the device itself.

At least certain operations that may have been illustrated in the figures show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments has been presented for the purposes of illustration and description. It is not intended to be exhaustive or to be limited to the precise forms disclosed. Many modifications and variations are possible in light of the above teaching.

### Examples

The following examples pertain to further embodiments.

Example 1 is a method for device simulation, in which a computational device generates a plurality of logical storage devices from a single physical storage device coupled to the computational device. A plurality of physical storage devices are simulated via the plurality of logical storage devices, where the plurality of physical storage devices and the single physical storage device are of a same type.

In example 2, the subject matter of example 1 may include partitioning the single physical storage device into a plurality of logical block address ranges, and mapping each logical block address range to a logical storage device of the plurality of logical storage devices.

In example 3, the subject matter of example 1 may include that the computational device communicates with the single physical storage device via a Non-Volatile Memory Express (NVMe) protocol, where the method further comprises: generating a plurality of namespaces from the single physical storage device; and mapping each namespace of the plurality of namespaces to a logical storage device of the plurality of logical storage devices.

In example 4, the subject matter of example 1 may include that an emulation layer in the computational device performs the generating of the plurality of logical storage devices and the simulating of the plurality of physical storage devices.

In example 5, the subject matter of example 4 may include that the emulation layer performs interfacing between an upper level storage driver and a storage controller driver of the single physical storage device, and where the method further comprises testing functions of the upper level storage driver and functions of the plurality of physical storage devices by the simulating of the plurality of physical storage devices.

In example 6, the subject matter of example 5 may include that the upper level storage driver configures the plurality of physical storage devices as a Redundant Array of Independent Disks (RAID).

In example 7, the subject matter of example 6 may include that testing of the functions of the upper level storage driver and testing of the functions of the plurality of physical storage devices are performed without coupling any additional physical storage device in addition to the single physical storage device that is coupled to the computational device.

In example 8, the subject matter of example 1 may include that the single physical storage device is adequate to simulate the plurality of physical storage devices, and wherein a command directed to any of the plurality of physical storage devices is directed to the single physical storage device.

Example 9 is a system for device simulation. The system is coupled to a single physical storage device, where the system comprises: a memory; and a processor coupled to the memory, wherein the processor is operable to: generate a plurality of logical storage devices from the single physical storage device; and simulate a plurality of physical storage devices via the plurality of logical storage devices, wherein the plurality of physical storage devices and the single physical storage device are of a same type.

In example 10, the subject matter of example 9 may include that the processor is further operable to: partition the single physical storage device into a plurality of logical block address ranges; and map each logical block address range to a logical storage device of the plurality of logical storage devices.

In example 11, the subject matter of example 9 may include that the system communicates with the single physical storage device via a Non-Volatile Memory Express (NVMe) protocol, where the processor is further operable to: generate a plurality of namespaces from the single physical storage device; and map each namespace of the plurality of namespaces to a logical storage device of the plurality of logical storage devices.

In example 12, the subject matter of example 9 may include that an emulation layer performs generating of the plurality of logical storage devices and simulating of the plurality of physical storage devices.

In example 13, the subject matter of example 12 may include that the emulation layer performs interfacing between an upper level storage driver and a storage controller driver of the single physical storage device, and where the processor is further operable to: test functions of the upper level storage driver and functions of the plurality of physical storage devices via simulation of the plurality of physical storage devices.

In example 14, the subject matter of example 13 may include that the upper level storage driver configures the plurality of physical storage devices as a Redundant Array of Independent Disks (RAID).

In example 15, the subject matter of example 14 may include that testing of the functions of the upper level storage driver and testing of the functions of the plurality of physical storage devices are performed without coupling any additional physical storage device in addition to the single physical storage device.

In example 16, the subject matter of example 9 may include that the single physical storage device is adequate to simulate the plurality of physical storage devices, and wherein a command directed to any of the plurality of physical storage devices is directed to the single physical storage device.

Example 17 is a computer readable storage medium for device simulation. having computer readable program code embodied therewith, the computer readable program code configured to perform operations on a computational device, the operations comprising: generating a plurality of logical storage devices from a single physical storage device coupled to the computational device; and simulating a plurality of physical storage devices via the plurality of logical storage devices, wherein the plurality of physical storage devices and the single physical storage device are of a same type.

In example 18, the subject matter of example 17 may include partitioning the single physical storage device into a plurality of logical block address ranges; and mapping each logical block address range to a logical storage device of the plurality of logical storage devices.

In example 19, the subject matter of example 17 may include that the computational device communicates with the single physical storage device via a Non-Volatile Memory Express (NVMe) protocol, the operations further comprising: generating a plurality of namespaces from the single physical storage device; and mapping each namespace of the plurality of namespaces to a logical storage device of the plurality of logical storage devices.

In example 20 the subject matter of example 17 may include that an emulation layer in the computational device performs the generating of the plurality of logical storage devices and the simulating of the plurality of physical storage devices.

In example 21 the subject matter of example 20 may include that the emulation layer performs interfacing between an upper level storage driver and a storage controller driver of the single physical storage device, and wherein the operations further comprises: testing functions of the upper level storage driver and functions of the plurality of physical storage devices by the simulating of the plurality of physical storage devices.

In example 22 the subject matter of example 21 may include that the upper level storage driver configures the plurality of physical storage devices as a Redundant Array of Independent Disks (RAID).

In example 23 the subject matter of example 22 may include that testing of the functions of the upper level storage driver and testing of the functions of the plurality of physical storage devices are performed without coupling any additional physical storage device in addition to the single physical storage device that is coupled to the computational device.

In example 24 the subject matter of example 17 may include that the single physical storage device is adequate to simulate the plurality of physical storage devices, and wherein a command directed to any of the plurality of physical storage devices is directed to the single physical storage device.

Example 25 is a system for device simulation, where the system comprises means for generating, in a computational device, a plurality of logical storage devices from a single physical storage device coupled to the computational device; and means for simulating a plurality of physical storage devices via the plurality of logical storage devices, wherein the plurality of physical storage devices and the single physical storage device are of a same type.

All optional features of any of the systems and/or apparatus and/or devices described above may also be implemented with respect to the method or process described above, and specifics in the examples may be used anywhere in one or more embodiments. Additionally, all optional features of the method or process described above may also be implemented with respect to any of the system and/or apparatus and/or devices described above, and specifics in the examples may be used anywhere in one or more embodiments.

What is claimed is:

1. A method, comprising:
generating, in a computational device, a plurality of logical storage devices from a single physical storage device coupled to the computational device; and
simulating a plurality of physical storage devices via the plurality of logical storage devices, wherein the plurality of physical storage devices and the single physical storage device are of a same type.

2. The method of claim 1, the method further comprising:
partitioning the single physical storage device into a plurality of logical block address ranges; and
mapping each logical block address range to a logical storage device of the plurality of logical storage devices.

3. The method of claim 1, wherein the computational device communicates with the single physical storage device via a Non-Volatile Memory Express (NVMe) protocol, the method further comprising:
generating a plurality of namespaces from the single physical storage device; and
mapping each namespace of the plurality of namespaces to a logical storage device of the plurality of logical storage devices.

4. The method of claim 1, wherein an emulation layer in the computational device performs the generating of the plurality of logical storage devices and the simulating of the plurality of physical storage devices.

5. The method of claim 4, wherein the emulation layer performs interfacing between an upper level storage driver and a storage controller driver of the single physical storage device, and wherein the method further comprises:
testing functions of the upper level storage driver and functions of the plurality of physical storage devices by the simulating of the plurality of physical storage devices.

6. The method of claim 5, wherein:
the upper level storage driver configures the plurality of physical storage devices as a Redundant Array of Independent Disks (RAID).

7. The method of claim 6, wherein testing of the functions of the upper level storage driver and testing of the functions of the plurality of physical storage devices are performed without coupling any additional physical storage device in addition to the single physical storage device that is coupled to the computational device.

8. The method of claim 1, wherein the single physical storage device is adequate to simulate the plurality of physical storage devices, and wherein a command directed to any of the plurality of physical storage devices is directed to the single physical storage device.

9. A system coupled to a single physical storage device, the system comprising:
a memory; and
a processor coupled to the memory, wherein the processor is operable to:
generate a plurality of logical storage devices from the single physical storage device; and
simulate a plurality of physical storage devices via the plurality of logical storage devices, wherein the plurality of physical storage devices and the single physical storage device are of a same type.

10. The system of claim 9, wherein the processor is further operable to:
partition the single physical storage device into a plurality of logical block address ranges; and
map each logical block address range to a logical storage device of the plurality of logical storage devices.

11. The system of claim 9, wherein the system communicates with the single physical storage device via a Non-Volatile Memory Express (NVMe) protocol, wherein the processor is further operable to:
generate a plurality of namespaces from the single physical storage device; and
map each namespace of the plurality of namespaces to a logical storage device of the plurality of logical storage devices.

12. The system of claim 9, wherein an emulation layer performs generating of the plurality of logical storage devices and simulating of the plurality of physical storage devices.

13. The system of claim 12, wherein the emulation layer performs interfacing between an upper level storage driver and a storage controller driver of the single physical storage device, and wherein the processor is further operable to:
test functions of the upper level storage driver and functions of the plurality of physical storage devices via simulation of the plurality of physical storage devices.

14. The system of claim 13, wherein:
the upper level storage driver configures the plurality of physical storage devices as a Redundant Array of Independent Disks (RAID).

15. The system of claim 14, wherein testing of the functions of the upper level storage driver and testing of the functions of the plurality of physical storage devices are performed without coupling any additional physical storage device in addition to the single physical storage device.

16. The system of claim 9, wherein the single physical storage device is adequate to simulate the plurality of physical storage devices, and wherein a command directed to any of the plurality of physical storage devices is directed to the single physical storage device.

17. A computer readable storage medium having computer readable program code embodied therewith, the computer readable program code configured to perform operations on a computational device, the operations comprising:
generating a plurality of logical storage devices from a single physical storage device coupled to the computational device; and
simulating a plurality of physical storage devices via the plurality of logical storage devices, wherein the plurality of physical storage devices and the single physical storage device are of a same type.

18. The computer readable storage medium of claim 17, the operations further comprising:
partitioning the single physical storage device into a plurality of logical block address ranges; and
mapping each logical block address range to a logical storage device of the plurality of logical storage devices.

19. The computer readable storage medium of claim 17, wherein the computational device communicates with the single physical storage device via a Non-Volatile Memory Express (NVMe) protocol, the operations further comprising:
generating a plurality of namespaces from the single physical storage device; and
mapping each namespace of the plurality of namespaces to a logical storage device of the plurality of logical storage devices.

20. The computer readable storage medium of claim 17, wherein an emulation layer in the computational device performs the generating of the plurality of logical storage devices and the simulating of the plurality of physical storage devices.

21. The computer readable storage medium of claim 20, wherein the emulation layer performs interfacing between an upper level storage driver and a storage controller driver of the single physical storage device, and wherein the operations further comprises:
testing functions of the upper level storage driver and functions of the plurality of physical storage devices by the simulating of the plurality of physical storage devices.

22. The computer readable storage medium of claim 21, wherein:
the upper level storage driver configures the plurality of physical storage devices as a Redundant Array of Independent Disks (RAID).

23. The computer readable storage medium of claim 22, wherein testing of the functions of the upper level storage driver and testing of the functions of the plurality of physical storage devices are performed without coupling any additional physical storage device in addition to the single physical storage device that is coupled to the computational device.

24. The computer readable storage medium of claim 17, wherein the single physical storage device is adequate to simulate the plurality of physical storage devices, and wherein a command directed to any of the plurality of physical storage devices is directed to the single physical storage device.
